(19) United States
(12) Patent Application Publication
(10) Pub. No.: US 2026/0236314 A1
(43) Pub. Date: Aug. 13, 2026

(54) HOST WORKLOAD PRIORITIZATION IN SPLIT EXTENDED REALITY (XR) SYSTEMS

(71) Applicant: QUALCOMM Incorporated, San Diego, CA (US)

(72) Inventors: Wesley James HOLLAND, Encinitas, CA (US); Simon Peter William BOOTH, San Diego, CA (US); Pawan Kumar BAHETI, San Diego, CA (US)

(21) Appl. No.: 19/474,667

(22) PCT Filed: Nov. 30, 2023
(86) PCT No.: PCT/US2023/081944

§ 371 Date: Oct. 10, 2025

(30) Foreign Application Priority Data
May 8, 2023 (IN) 202341032402

(51) Int. Cl. G06F 9/50; G06F 1/08; G06F 1/16

(52) U.S. Cl. CPC G06F 9/505; G06F 1/08; G06F 1/163

(57) ABSTRACT

A method for workload scheduling by a host device communicating with a head mounted display includes prioritizing processing of a first head mounted display (HMD) task in response to determining the host device is within a target wake time (TWT) window. The method also includes prioritizing processing of a host task in response to determining the host device is outside of the TWT window. The method may further include evaluating whether increasing processing core voltage and/or increasing processing core clock frequency would allow the host task to complete in time to allow enough time for a second head mounted display (HMD) task to finish processing before a next TWT window ends.

### CROSS-REFERENCE TO RELATED APPLICATION

The present application claims the benefit of India Patent Application No. 202341032402, filed on May 8, 2023, and titled “HOST WORKLOAD PRIORITIZATION IN SPLIT EXTENDED REALITY (XR) SYSTEMS,” the disclosure of which is expressly incorporated by reference in its entirety.

### BACKGROUND

### Field

Aspects of the present disclosure relate to computing devices, and more specifically to host workload prioritization in split extended reality (XR) systems.

### Background

Mobile or portable computing devices include mobile phones, laptops, palmtop and tablet computers, portable digital assistants (PDAs), portable game consoles, and other portable electronic devices. Mobile computing devices are comprised of many electrical components that consume power and generate heat. The components (or compute devices) may include system-on-a-chip (SoC) devices, graphics processing unit (GPU) devices, neural processing unit (NPU) devices, digital signal processors (DSPs), and modems, among others.

Extended reality (XR) includes virtual reality (VR), mixed reality (MR), and augmented reality (AR). Augmented reality is the augmentation of the real (e.g., physical) world with virtual content. This augmentation can be accomplished with a wearable AR device capable of mapping the physical world, localizing itself in that physical world, and positioning and rendering virtual content on a near-eye display visible to the user. Many such devices utilize hand and/or fingertip tracking to allow users to control interfaces in augmented reality. It would be desirable to improve processing in XR devices.

### SUMMARY

In aspects of the present disclosure, a method for workload scheduling by a host device communicating with a head mounted display includes prioritizing processing of a head mounted display task in response to determining the host device is within a target wake time (TWT) window.

Other aspects of the present disclosure are directed to an apparatus. The apparatus has at least one memory and one or more processors coupled to the at least one memory. The processor(s) is configured to prioritize processing of a head mounted display task in response to determining the host device is within a target wake time (TWT) window.

Other aspects of the present disclosure are directed to an apparatus. The apparatus includes means for prioritizing processing of a head mounted display task in response to determining the host device is within a target wake time (TWT) window. The apparatus further includes means for prioritizing processing of a host task in response to determining the host device is outside of the TWT window.

In other aspects of the present disclosure, a non-transitory computer-readable medium with program code recorded thereon is disclosed. The program code is executed by a processor and includes program code to prioritize processing of a head mounted display task in response to determining the host device is within a target wake time (TWT) window.

This has outlined, rather broadly, the features and technical advantages of the present disclosure in order that the detailed description that follows may be better understood. Additional features and advantages of the present disclosure are described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram illustrating an example implementation of a host system-on-a-chip (SoC), including a target wake time (TWT)-aware scheduler, in accordance with certain aspects of the present disclosure.

FIG. 2 is a block diagram illustrating an example of a split extended reality (XR) pipeline, in accordance with certain aspects of the present disclosure.

FIG. 3 is a timing diagram illustrating an example of a TWT timeline, in accordance with certain aspects of the present disclosure.

FIG. 4 is a flow diagram illustrating an example of TWT-aware workload scheduling and scaling for compute engines on a host, in accordance with certain aspects of the present disclosure.

FIG. 5 is a flow diagram illustrating an example process performed, for example, by a host device, in accordance with various aspects of the present disclosure.

FIG. 6 is a block diagram showing an exemplary wireless communications system in which a configuration of the present disclosure may be advantageously employed.

FIG. 7 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Extended reality (XR) includes virtual reality (VR), mixed reality (MR), and augmented reality (AR). Augmented reality is the augmentation of the real (e.g., physical) world with virtual content for processes such as room designing, virtual shopping, tabletop AR games, turn-by turn navigation assistance, food and health monitoring, AR video calls, and virtual meetings. This augmentation can be accomplished with a wearable AR device capable of mapping the physical world, localizing itself in that physical world, and positioning and rendering virtual content on a near-eye display visible to the user. Many such devices utilize hand and/or fingertip tracking to allow users to control interfaces in augmented reality. Because of the small form-factor required for XR head mounted displays (HMDs) (e.g., dictated by fashion, comfort, etc.), the thermal constraints are challenging. Because the HMD devices are typically worn on a person's head, HMDs also have weight and design constraints.

One approach to reduce power consumption in the XR HMD is to split processing between the HMD and a host device, such as a puck or cell phone. Split XR systems offload some HMD computations to the host device. Although split XR systems address the computational constraints of HMDs, split XR systems are themselves subject to latency and workload considerations.

In split designs, some implementations perform rendering, which is a high-power workload, on a companion device. Performing rendering on the companion device, however, necessitates a late-stage reprojection on the glasses (e.g., HMD) to reduce motion-to-photon latency and avoid user nausea. The late-stage reprojection reprojects the previously-rendered frame for the latest head pose. For example, if a user's head has moved since the rendering in the companion device, the headset warps the rendering based on the updated head pose. Perception workloads (e.g., hand tracking, head tracking, body tracking, three-dimensional (3D) reconstructions, etc.) may be processed either on the glasses or the companion device, depending on latency and power requirements.

In split XR systems, it is often desirable to lower wireless local area network (WLAN) (e.g., WI-FI) power on the HMD by utilizing a target wake time (TWT) feature. TWT is a feature of WI-FI 6 that allows agent traffic to be scheduled to particular wake windows and sleep the remainder of the time. The sender and receiver agree on a time to wakeup radios, improving the power profile by allowing the radios to sleep at other times.

In cases where the host or companion device is a cell phone, that cell phone has native workloads, for example, home screen processing, running applications, processing notifications, etc., that must be balanced and scheduled alongside rendering or perception workloads for the XR HMD. If this balancing is performed improperly, host workloads may cause the host to miss the TWT timeline. It would be desirable to improve processing in split XR devices.

Aspects of the present disclosure introduce TWT-aware workload scheduling and scaling for compute engines on a host device. According to these aspects, the host workloads are delayed until immediately after a TWT window. These host tasks may include processes such as gameplay on the host device, home screen processing, etc.

In some aspects, the scheduler may elevate corners for processing host tasks, if necessary, to complete the host tasks in time for the HMD tasks to finish for a next TWT window. If host workloads cannot complete in time for HMD workloads to finish for the next TWT window (even with elevated corners), host workloads may be preempted and delayed until after the next TWT window.

Elevating corners includes increasing a voltage of a processor core and/or increasing a clock frequency of the processing core. The power penalty associated with the elevated corners may be deemed acceptable in these instances. In some aspects, a lowest frequency and voltage corner is determined that would allow completion in time. A margin (e.g., 5%) may be added to the estimates to account for uncertainty while ensuring completion of the host tasks. A hysteresis may be added to ensure the corners do not change too frequently. For example, a time since the last change in corner parameters may be determined. If the time is less than a threshold value, the corner may be prevented from changing again.

Particular aspects of the subject matter described in this disclosure can be implemented to realize one or more of the following potential advantages. In some examples, the described techniques, such as prioritizing processing of head mounted display tasks in response to determining the host device is within a target wake time (TWT) window improves power consumption for split XR systems. Moreover, lower motion to render to photon latency is achieved.

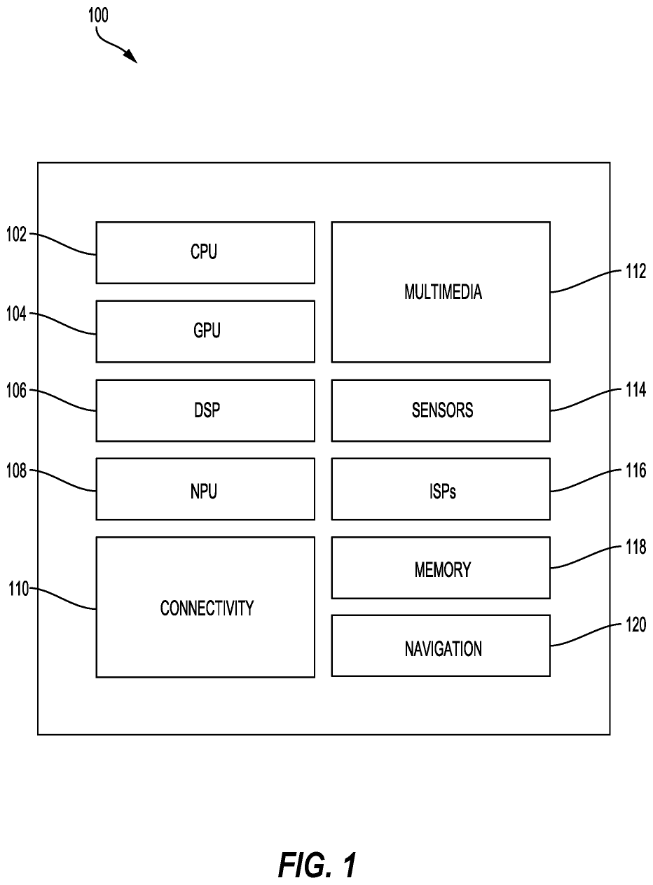

FIG. 1 illustrates an example implementation of a host system-on-a-chip (SoC) 100, which includes a TWT-aware scheduler, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, WI-FI connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

According to aspects of the present disclosure, a host device includes means for prioritizing, means for delaying, means for evaluating, and means for processing. In one configuration, the calculating means may be the CPU, GPU, DSP, NPU or ISP, as shown in FIG. 1. In other aspects, the aforementioned means may be any structure or any material configured to perform the functions recited by the aforementioned means.

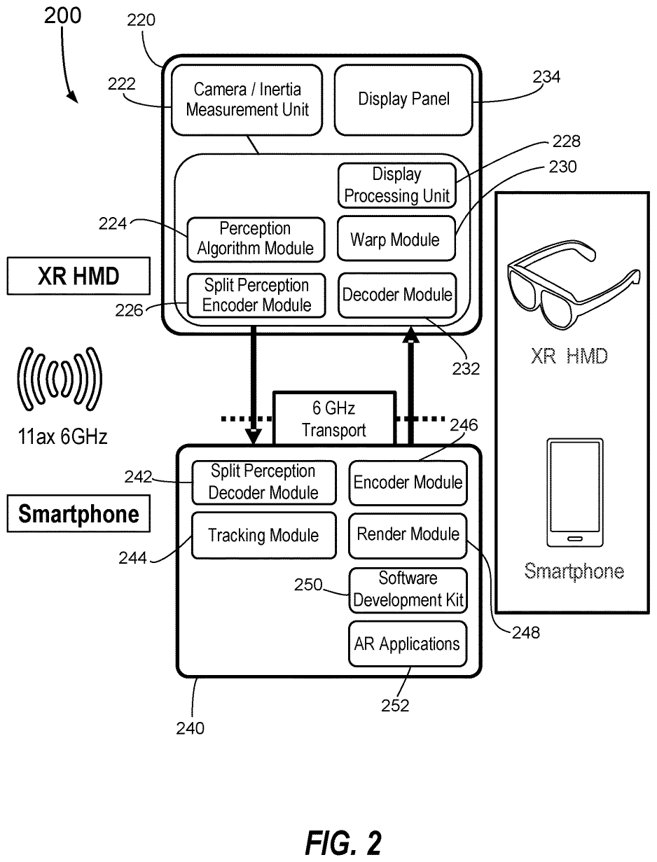

FIG. 2 is a block diagram illustrating an example of a split extended reality (XR) pipeline, in accordance with certain aspects of the present disclosure. As shown in FIG. 2, the split XR pipeline 200 may include a head mounted display (HMD) 220 and a host device 240 (e.g., a smartphone) in communication with the HMD 220. The HMD communicates with the host device 240 over a communications network, such as a WI-FI network. The HMD 220 may comprise a camera/inertia measurement unit (IMU) 222, a perception algorithm module 224, a split perception encoder module 226, a display processing unit (DPU) 228, a warp module 230, a decoder module 232, and a display panel 234. The camera/IMU 222 captures and records perception information from the HMD's 220 environment and movement. This perception information may be processed into head-pose information by a perception algorithm in the perception algorithm module 224. The perception algorithm module 224 in this example incorporates a six degrees of freedom (DOF) algorithm for head-pose tracking. The split perception encoder module 226 transforms the head-pose information and/or perception information into a digital or analog signal. The HMD 220 then transmits this signal over a communications network, such as a WI-FI 6 network, to the host device 240.

The host device 240 receives the transmission from the HMD 220. The host device 240 may comprise a split perception decoder module 242, a tracking module 244, an encoder module 246, a render module 248, a software development kit (SDK) 250, and AR applications 252. The tracking module 244 incorporates hand tracking, plane finding, image tracking, and object tracking. The split perception decoder module 242 converts the transmission into information to be used by the render module 248 or another module in the host device 240. The tracking module 244 uses the decoded information to conduct the hand tracking, plane finding, image tracking, and/or object tracking in connection with the HMD 220. The SDK 250 may comprise one or more software tools, libraries, and documentation to develop, test, or integrate software applications on the host device 240 or another platform. The AR applications 252 may comprise one or more device applications facilitating augmented reality, extended reality, and or virtual reality on the host device 240. The render module 248 can use a combination of information from the split perception decoder module 242 and/or tracking data from the tracking module 244, as well as other information from the host device 240 or the HMD 220, to generate a visual representation of a 3D model or scene for display purposes. The host device 240 can encode the rendering for transmission back to the HMD 220 via the encoder module 246.

The HMD 220 receives the transmission from the host device 240 and decodes the transmission with the decoder module 232. This decoded transmission produces rendering information that may then be used by the warp module 230 and/or the DPU 228. The DPU 228 is a component for rendering and controlling the visual content displayed on the display panel 234. The warp module 230 is a component for applying geometric transformations to a rendering so as to correct for optical distortions, adjust perspective, or map a rendering onto a non-flat surface. The warp module 230 and the DPU 228 may use information from the perception algorithm module 224, the camera/IMU 222, and/or the host device 240 to distort and/or manipulate the rendering information into a finished rendering. This finished rendering displays as virtual content on the display panel 234, the display panel 234 being a surface capable of displaying visual information.

In split XR systems, it is often desirable to lower power consumption for communications on the HMD by utilizing a target wake time (TWT). TWT is a feature of WI-FI 6 that allows agent traffic to be scheduled to particular wake windows so that the device can sleep the remainder of the time.

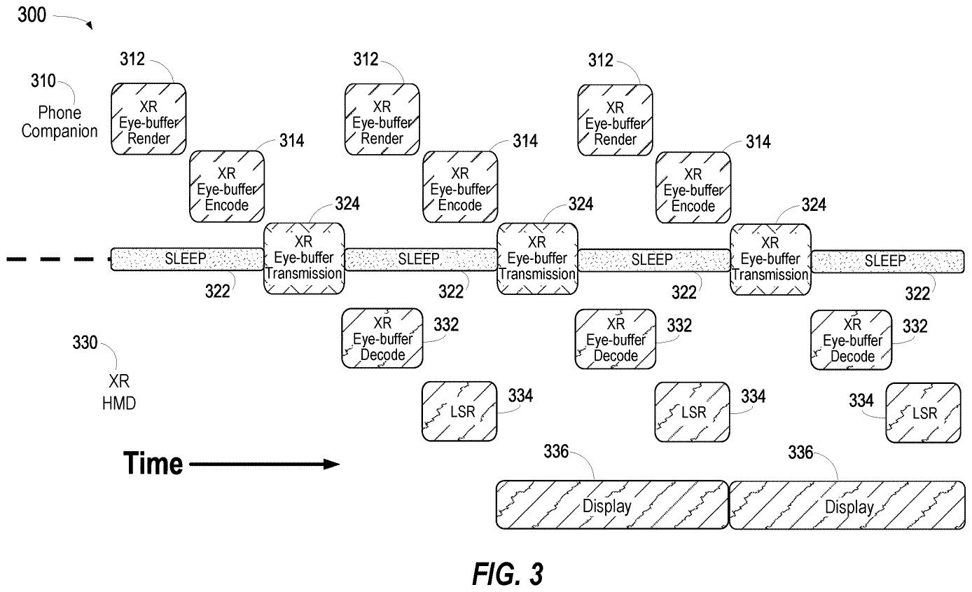

FIG. 3 is a timing diagram illustrating an example of a TWT timeline, in accordance with certain aspects of the present disclosure. As shown in FIG. 3, the TWT timeline 300 illustrates actions taken by a host device 310 and an HMD 330, which may be the same host device 240 and the HMD 220 of FIG. 2. In the example of FIG. 3, the host device 310 is a phone companion and the HMD 330 is an XR HMD. At the beginning of the time period illustrated by the TWT timeline 300, the host device 310 renders eye-buffer information at an XR eye-buffer render stage 312 based on head-pose information provided by the host device 310 and/or the HMD 330. This eye-buffer information may contain data necessary for displaying virtual content. The eye-buffer information is then encoded by the host device 310 at an XR eye-buffer encode stage 314. During the XR eye-buffer render stage 312 and the XR eye-buffer encode stage 314, the host device 310 and the HMD 330 conduct little or no communication with each other, as illustrated by a sleep stage 322. The sleep stage 322 is sometimes referred to as the “sleep window.”

After the host device 310 completes the XR eye-buffer encode stage 314, the host device 310 transmits information to the HMD 330 via a communications network, as illustrated by an XR eye-buffer transmission stage 324. The XR eye-buffer transmission stage 324 is sometimes referred to as the “wake window.” Upon receiving the transmitted information from the host device 310, the HMD 330 decodes the transmission at an XR eye-buffer decode stage 332. The HMD 330 then modifies the decoded information at a late-stage reprojection (LSR) block 334. At the late-stage reprojection block 334, the HMD 330 produces virtual content by using one or more techniques to reproject a 3D scene onto a 2D screen or image plane. This virtual content is then displayed on a display panel at a display stage 336.

As shown in FIG. 3, stages in the TWT timeline 300 may repeat in cycles. For example, after the host device 310 transmits information during the XR eye-buffer transmission stage 324, the host device 310 may immediately re-enter the XR eye-buffer render stage 312. Further, one stage in the TWT timeline 300 may overlap with another stage. The host device 310 and the HMD 330 may operate in parallel where the host device 310 processes at one stage while the HMD 330 processes at another stage. This parallelism may also extend to the devices themselves. The HMD 330 may process at one stage and, at the same time, process a different stage. For example, the display stage 336 may occur in parallel with the late-stage reprojection block 334. The host device 310 may also perform processing at one stage and, at the same time, process a different stage. The HMD 330 and the host device 310 may further process their own stages during either the sleep stage 322 or the XR eye-buffer transmission stage 324.

In cases where the host or companion device is a cell phone, that cell phone has native workloads, for example, home screen, applications, notifications, etc., that must be balanced and scheduled alongside rendering or perception workloads for the XR HMD. If this balancing is performed improperly, host workloads may cause the host to miss processing according to the TWT timeline. Aspects of the present disclosure introduce a TWT-aware workload scheduling and scaling technique for compute engines on a host device. In some configurations, these techniques have several key aspects. For example, in these configurations, (1) host workloads may be delayed until immediately after a TWT window, (2) the scheduler is capable of elevating processing corners on host workloads if necessary to complete the host workloads in time for HMD workloads to finish for the TWT window, and (3) if host workloads cannot complete in time for HMD workloads to finish for the TWT window, host workloads may be preempted and delayed until after a next TWT window.

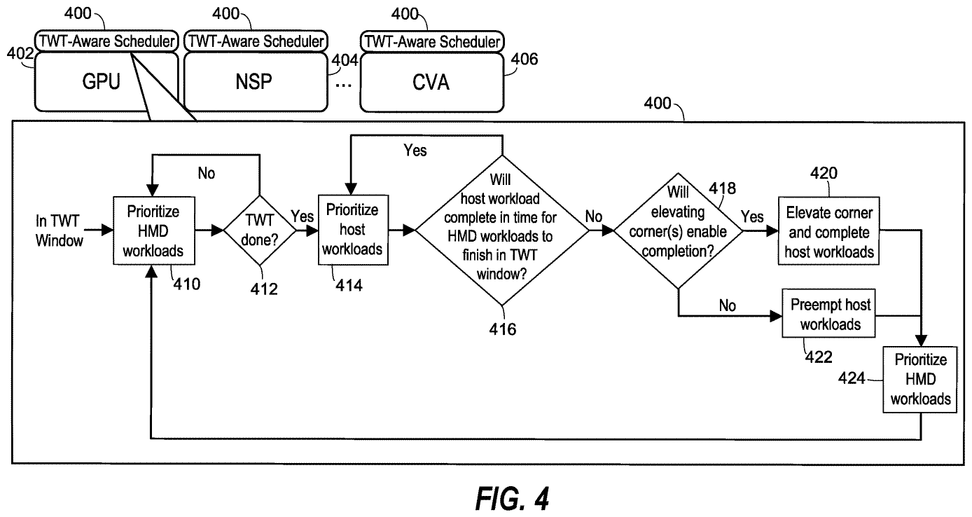

FIG. 4 is a flow diagram illustrating an example of TWT-aware workload scheduling and scaling for compute engines on a host, in accordance with certain aspects of the present disclosure. As shown in FIG. 4, the TWT-aware scheduler 400 preforms a process for prioritizing workloads. In some aspects, the TWT-aware scheduler 400 may be performed on one or more agents on the companion device, including a graphics processing unit (GPU) 402, a neural signal processor (NSP) 404, and/or the computer vision accelerator (CVA) 406. Although these components are shown in FIG. 4, the processing may occur in other components, such as those shown in FIG. 1, for example, the GPU 104, multi-core CPU 102, NPU 108, etc.

At block 410, the agent prioritizes HMD workloads during a TWT wake window. The process then proceeds to block 412. At block 412, the agent determines if the TWT window has completed. If, at block 412, the TWT window has not completed (block 412: NO), the agent continues prioritizing HMD workloads at block 410. If, at block 412, the TWT window has completed (block 412: YES), the process proceeds to block 414. At block 414, the agent prioritizes host workloads. The process then proceeds to block 416. At block 416, the agent determines if a host workload will complete in time for HMD workloads to finish in the TWT window. If, at block 416, the host workload will complete in time for HMD workloads to finish in the TWT window (block 416: YES), the agent continues prioritizing host workloads at block 414. If, at block 416, it is determined that the host workload will not complete in time for HMD workloads to finish in the TWT window (block 416: NO), then the process proceeds to block 418.

At block 418, the agent determines if elevating one or more corners will enable the agent to complete the host workload while outside of the TWT window. If, at block 418, it is determined that elevating the one or more corners will enable the agent to complete the host workload while outside of the TWT window (block 418: YES), the agent may then elevate one or more corners and complete the host workloads at block 420 and then prioritize HMD workloads at block 424. For example, the agent may increase the clock frequency of the device processing core to the minimum voltage and frequency required to complete the host workload while outside of the TWT window. In another example, the agent may determine the minimum voltage and frequency required to complete the host workload while outside of the TWT window, and then, for added certainty, increase voltage and/or frequency to an amount higher than the minimum voltage and frequency required.

If, at block 418, it is determined that elevating the corners will not enable the agent to complete the host workload while outside of the TWT window, or if elevating the corners is not a feasible or otherwise ideal solution (block 418: NO), the agent may preempt the host workloads at block 422 and then prioritize the HMD workloads at block 424. An example of when elevating the corners may not be a desired solution is when the agent has recently elevated or otherwise changed the corners. The process then proceeds to block 410, where the agent prioritizes HMD workloads while within the TWT window. The agent may then repeat the TWT-aware scheduler process in cycles.

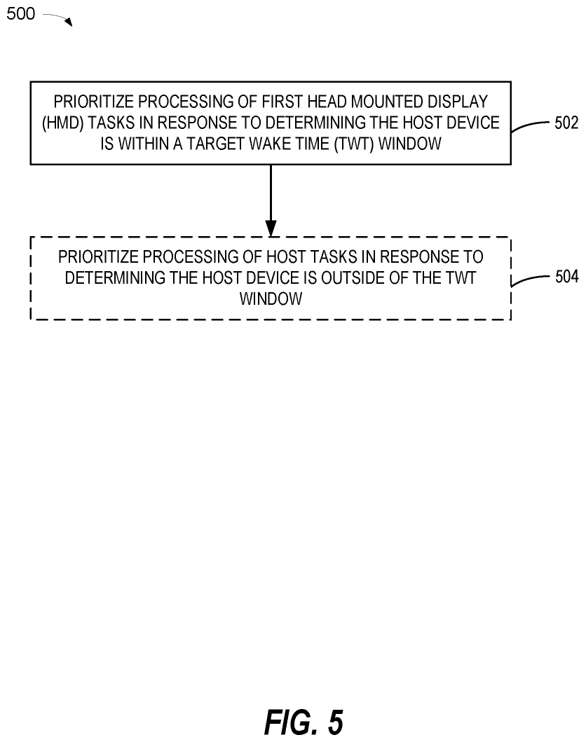

FIG. 5 is a flow diagram illustrating an example process 500 performed, for example, by a host device, in accordance with various aspects of the present disclosure. The example process 500 is an example of TWT-aware scheduling. As shown in FIG. 5, in some aspects, the process 500 may include prioritizing processing of a first head mounted display (HMD) task in response to determining the host device is within a target wake time (TWT) window (block 502). Examples of head mounted display task may include late-stage reprojection (LSR) and perception. In some aspects, the process 500 may optionally include prioritizing processing of a host task in response to determining the host device is outside of the TWT window (block 504). Examples of host tasks may include rendering and object tracking.

In some aspects, the process 500 may perform one or more actions to prioritize an HMD task during a TWT window and prioritize a host task while outside of a TWT window. For example, the host device may evaluate whether increasing processing core voltage and/or increasing processing core clock frequency would allow the host task to complete in time to allow enough time for a second HMD task to finish processing before a next TWT window ends. The host device may also process the host task with increased processing core voltage and/or increased processing core clock frequency in response to the host task being able to complete in time. In some aspects, the host device may delay processing of the host task in response to the host task not being able to complete in time with increased processing core voltage and/or increased processing core clock frequency. In other aspects, the host device may delay processing of the host task until after the next TWT window ends or until the second HMD task is completed. In still further aspects, the host device may delay processing of the host task in response to determining the host task cannot complete in time to allow enough time for a second HMD task to finish processing before a next TWT window ends until the second HMD task is completed.

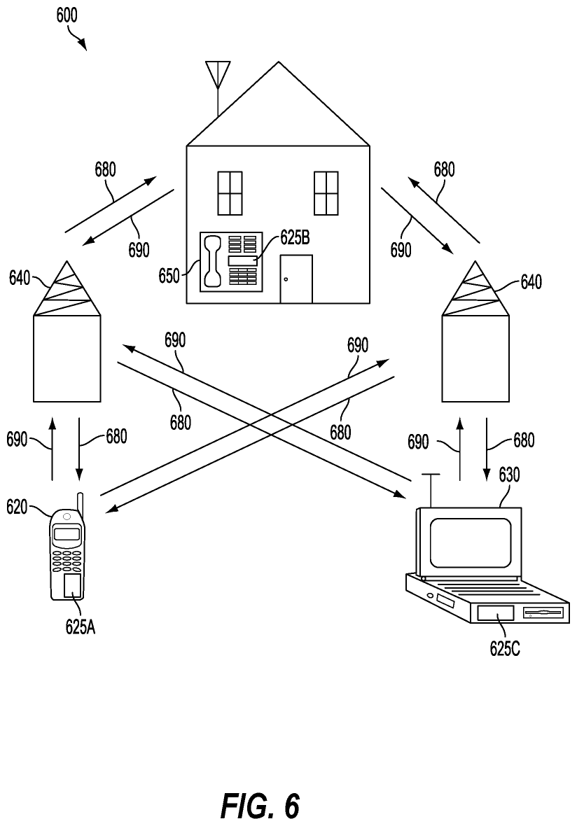

FIG. 6 is a block diagram showing an exemplary wireless communications system 600, in which an aspect of the present disclosure may be advantageously employed. For purposes of illustration, FIG. 6 shows three remote units 620, 630, and 650, and two base stations 640. It will be recognized that wireless communications systems may have many more remote units and base stations. Remote units 620, 630, and 650 include integrated circuit (IC) devices 625A, 625B, and 625° C. that include the disclosed TWT-aware scheduler. It will be recognized that other devices may also include the disclosed TWT-aware scheduler, such as the base stations, switching devices, and network equipment. FIG. 6 shows forward link signals 680 from the base stations 640 to the remote units 620, 630, and 650, and reverse link signals 690 from the remote units 620, 630, and 650 to the base stations 640.

In FIG. 6, remote unit 620 is shown as a mobile telephone, remote unit 630 is shown as a portable computer, and remote unit 650 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 6 illustrates remote units according to the aspects of the present disclosure, the disclosure is not limited to these exemplary illustrated units. Aspects of the present disclosure may be suitably employed in many devices, which include the disclosed TWT-aware scheduler.

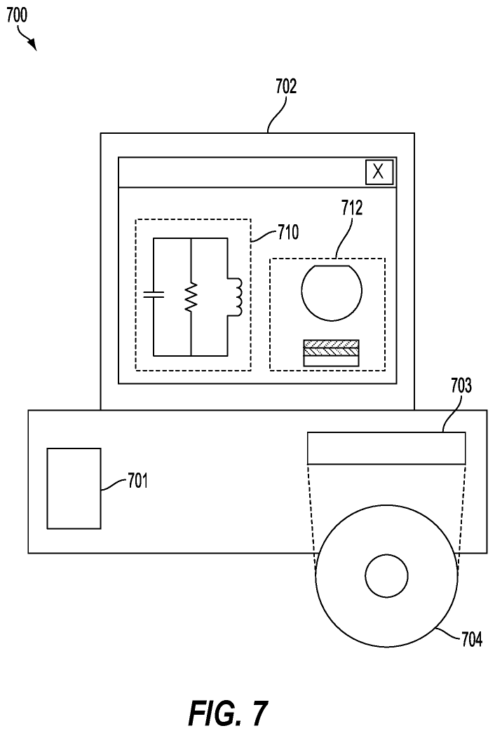

FIG. 7 is a block diagram illustrating a design workstation 700 used for circuit, layout, and logic design of a semiconductor component, such as the TWT-aware scheduler, disclosed above. The design workstation 700 includes a hard disk 701 containing operating system software, support files, and design software such as Cadence or OrCAD. The design workstation 700 also includes a display 702 to facilitate design of a circuit 710 or a semiconductor component 712, such as the TWT-aware scheduler. A storage medium 704 is provided for tangibly storing the design of the circuit 710 or the semiconductor component 712 (e.g., the PLD). The design of the circuit 710 or the semiconductor component 712 may be stored on the storage medium 704 in a file format such as GDSII or GERBER. The storage medium 704 may be a CD-ROM, DVD, hard disk, flash memory, or other appropriate device. Furthermore, the design workstation 700 includes a drive apparatus 703 for accepting input from or writing output to the storage medium 704.

Data recorded on the storage medium 704 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 704 facilitates the design of the circuit 710 or the semiconductor component 712 by decreasing the number of processes for designing semiconductor wafers.

### EXAMPLE ASPECTS

Aspect 1: A method of workload scheduling by a host device communicating with a head mounted display, the method comprising prioritizing processing of a first head mounted display (HMD) task in response to determining the host device is within a target wake time (TWT) window.

Aspect 2: The method of Aspect 1, further comprising prioritizing processing of a host task in response to determining the host device is outside of the TWT window.

Aspect 3: The method of Aspect 1 or 2, further comprising evaluating whether increasing processing core voltage and/or increasing processing core clock frequency would allow the host task to complete in time to allow enough time for a second head mounted display (HMD) task to finish processing before a next TWT window ends.

Aspect 4: The method of any of the preceding Aspects, further comprising processing the host task with increased processing core voltage and/or increased processing core clock frequency in response to the host task being able to complete in time.

Aspect 5: The method of any of the preceding Aspects, further comprising delaying processing of the host task in response to the host task not being able to complete in time with increased processing core voltage and/or increased processing core clock frequency.

Aspect 6: The method of any of the preceding Aspects, in which the delaying is until after the next TWT window ends or until the second HMD task is completed.

Aspect 7: The method of any of the preceding Aspects, further comprising delaying processing of a host task, in response to determining the host task cannot complete in time to allow enough time for a second head mounted display (HMD) task to finish processing before a next TWT window ends, until the second HMD task is completed.

Aspect 8: An apparatus for workload scheduling by a host device communicating with a head mounted display, comprising: at least one memory; and at least one processor coupled to the at least one memory, the at least one processor configured to prioritize processing of a first head mounted display (HMD) task in response to determining the host device is within a target wake time (TWT) window.

Aspect 9: The apparatus of Aspect 8, in which the at least one processor is further configured to prioritize processing of a host task in response to determining the host device is outside of the TWT window.

Aspect 10: The apparatus of Aspect 8 or 9, in which the at least one processor is further configured to evaluate whether increasing processing core voltage and/or increasing processing core clock frequency would allow the host task to complete in time to allow enough time for a second head mounted display (HMD) task to finish processing before a next TWT window ends.

Aspect 11: The apparatus of Aspect 8-10, in which the at least one processor is further configured to process the host task with increased processing core voltage and/or increased processing core clock frequency in response to the host task being able to complete in time.

Aspect 12: The apparatus of Aspect 8-11, in which the at least one processor is further configured to delay processing of the host task in response to the host task not being able to complete in time with increased processing core voltage and/or increased processing core clock frequency.

Aspect 13: The apparatus of Aspect 8-12, in which the at least one processor configured to delay processing is further configured to delay until after the next TWT window ends or until the second HMD task is completed.

Aspect 14: The apparatus of Aspect 8-13, in which the at least one processor is further configured to delay processing of a host task, in response to determining the host task cannot complete in time to allow enough time for a second head mounted display (HMD) task to finish processing before a next TWT window ends, until the second HMD task is completed.

Aspect 15: A non-transitory computer-readable medium having program code recorded thereon, the program code executed by a processor and comprising program code to prioritize processing of a first head mounted display (HMD) task in response to determining a host device is within a target wake time (TWT) window.

Aspect 16: The non-transitory computer-readable medium of Aspect 15, in which the program code further comprises program code to prioritize processing of a host task in response to determining the host device is outside of the TWT window.

Aspect 17: The non-transitory computer-readable medium of Aspect 15 or 16, in which the program code further comprises program code to evaluate whether increasing processing core voltage and/or increasing processing core clock frequency would allow the host task to complete in time to allow enough time for a second head mounted display (HMD) task to finish processing before a next TWT window ends.

Aspect 18: The non-transitory computer-readable medium of Aspect 15-17, in which the program code further comprises program code to process the host task with increased processing core voltage and/or increased processing core clock frequency in response to the host task being able to complete in time.

Aspect 19: The non-transitory computer-readable medium of Aspect 15-18, in which the program code further comprises program code to delay processing of the host task in response to the host task not being able to complete in time with increased processing core voltage and/or increased processing core clock frequency.

Aspect 20: The non-transitory computer-readable medium of Aspect 15-19, in which the program code to delay processing comprises program code to delay until after the next TWT window ends or until the second HMD task is completed.

Aspect 21: The non-transitory computer-readable medium of Aspect 15-20, in which the program code further comprises program code to delay processing of a host task, in response to determining the host task cannot complete in time to allow enough time for a second head mounted display (HMD) task to finish processing before a next TWT window ends, until the second HMD task is completed.

Aspect 22: An apparatus for workload scheduling by a host device communicating with a head mounted display, comprising: means for prioritizing processing of a first head mounted display (HMD) task in response to determining the host device is within a target wake time (TWT) window; and means for prioritizing processing of a host task in response to determining the host device is outside of the TWT window.

Aspect 23: The apparatus of Aspect 22, further comprising means for evaluating whether increasing processing core voltage and/or increasing processing core clock frequency would allow the host task to complete in time to allow enough time for a second head mounted display (HMD) task to finish processing before a next TWT window ends.

Aspect 24: The apparatus of Aspect 22 or 23, further comprising means for processing the host task with increased processing core voltage and/or increased processing core clock frequency in response to the host task being able to complete in time.

Aspect 25: The apparatus of Aspect 22-24, further comprising means for delaying processing of the host task in response to the host task not being able to complete in time with increased processing core voltage and/or increased processing core clock frequency.

Aspect 26: The apparatus of Aspect 22-25, in which the means for delaying processing further comprises means for delaying until after the next TWT window ends or until the second HMD task is completed.

Aspect 27: The apparatus of Aspect 22-26, further comprising means for delaying processing of the host task in response to determining the host task cannot complete in time to allow enough time for a second head mounted display (HMD) task to finish processing before a next TWT window ends, until the second HMD task is completed.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

1. A method of workload scheduling by a host device communicating with a head mounted display, the method comprising prioritizing processing of a first head mounted display (HMD) task in response to determining the host device is within a target wake time (TWT) window.

2. The method of claim 1. further comprising prioritizing processing of a host task in response to determining the host device is outside of the TWT window.

3. The method of claim 2, further comprising evaluating whether increasing processing core voltage and/or increasing processing core clock frequency would allow the host task to complete in time to allow enough time for a second head mounted display (HMD) task to finish processing before a next TWT window ends.

4. The method of claim 3, further comprising processing the host task with increased processing core voltage and/or increased processing core clock frequency in response to the host task being able to complete in time.

5. The method of claim 3, further comprising delaying processing of the host task in response to the host task not being able to complete in time with increased processing core voltage and/or increased processing core clock frequency.

6. The method of claim 5, in which the delaying is until after the next TWT window ends or until the second HMD task is completed.

7. The method of claim 1, further comprising delaying processing of a host task, in response to determining the host task cannot complete in time to allow enough time for a second head mounted display (HMD) task to finish processing before a next TWT window ends, until the second HMD task is completed.

8. An apparatus for workload scheduling by a host device communicating with a head mounted display, comprising:
at least one memory; and
at least one processor coupled to the at least one memory, the at least one processor configured to prioritize processing of a first head mounted display (HMD) task in response to determining the host device is within a target wake time (TWT) window.

9. The apparatus of claim 8, in which the at least one processor is further configured to prioritize processing of a host task in response to determining the host device is outside of the TWT window.

10. The apparatus of claim 9, in which the at least one processor is further configured to evaluate whether increasing processing core voltage and/or increasing processing core clock frequency would allow the host task to complete in time to allow enough time for a second head mounted display (HMD) task to finish processing before a next TWT window ends.

11. The apparatus of claim 10, in which the at least one processor is further configured to process the host task with increased processing core voltage and/or increased processing core clock frequency in response to the host task being able to complete in time.

12. The apparatus of claim 10, in which the at least one processor is further configured to delay processing of the host task in response to the host task not being able to complete in time with increased processing core voltage and/or increased processing core clock frequency.

13. The apparatus of claim 12, in which the at least one processor configured to delay processing is further configured to delay until after the next TWT window ends or until the second HMD task is completed.

14. The apparatus of claim 8, in which the at least one processor is further configured to delay processing of a host task, in response to determining the host task cannot complete in time to allow-enough time for a second head mounted display (HMD) task to finish processing before a next TWT window ends, until the second HMD task is completed.

15. A non-transitory computer-readable medium having program code recorded thereon, the program code executed by a processor and comprising program code to prioritize processing of a first head mounted display (HMD) task in response to determining a host device is within a target wake time (TWT) window.

16. The non-transitory computer-readable medium of claim 15, in which the program code further comprises program code to prioritize processing of a host task in response to determining the host device is outside of the TWT window.

17. The non-transitory computer-readable medium of claim 16, in which the program code further comprises program code to evaluate whether increasing processing core voltage and/or increasing processing core clock frequency would allow the host task to complete in time to allow enough time for a second head mounted display (HMD) task to finish processing before a next TWT window ends.

18. The non-transitory computer-readable medium of claim 17, in which the program code further comprises program code to process the host task with increased processing core voltage and/or increased processing core clock frequency in response to the host task being able to complete in time.

19. The non-transitory computer-readable medium of claim 17, in which the program code further comprises program code to delay processing of the host task in response to the host task not being able to complete in time with increased processing core voltage and/or increased processing core clock frequency.

20. The non-transitory computer-readable medium of claim 19, in which the program code to delay processing comprises program code to delay until after the next TWT window ends or until the second HMD task is completed.

21-27. (canceled)
